(19) United States
(12) Patent Application Publication
(10) Pub. No.: US 2009/0314361 A1
(43) Pub. Date: Dec. 24, 2009

(54) Compressor and Method for Welding a Fluid Tubing to a Compressor Housing and a Fluid-Transport Tubing

(76) Inventor: Alberto Jose Silveira, Joinville (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/438,376

(22) PCT Filed: Jun. 1, 2007
(86) PCT No.: PCT/BR07/00133

§ 371 Date: Jul. 30, 2009

(30) Foreign Application Priority Data
Aug. 22, 2006 (BR) PI0603392-0

(51) Int. Cl. F04B 39/12; B23K 11/00; F16L 13/02

(52) U.S. Cl. 137/565.01; 219/136; 219/137 R; 285/288.11

(57) ABSTRACT

The present invention relates to a compressor, a method of welding a fluid tubing to a compressor housing, and a fluid-transport tubing, particularly applicable to an airtight compressor, which provide for the replacement of the brazing step and the direct welding of the fluid-passage tubing to the compressor housing. The airtight compressor comprises a housing (5) and a fluid-transport tubing (9), the fluid-transport tubing passing through the housing (5) through a passage orifice (10), the fluid-transport tubing (9) comprising weldable coupling means (11), the weidable coupling means (110) being configured from a widening in the diameter of the fluid-transport tubing (9), the widening in the diameter having a dimension larger than the diameter of the passage orifice (10) and being configured along its length, the weldable means (11) being welded directly close to a border (12′) of the passage orifice (10). A method of welding the fluid tubing to a compressor housing, as well as a fluid-transport tubing, particularly applicable to an airtight compressor, are also described.

The present invention relates to a compressor, a method of welding fluid-passage tubing to a compressor housing, and a fluid-transport tubing, particularly applicable to an airtight compressor, which provide for the replacement of the brazing step and provides the direct welding of the fluid-passage tubing to the compressor housing.

### DESCRIPTION OF THE PRIOR ART

Airtight compressors used in cooling systems are mounted on a steel housing and sealed by welding. The connecting tubes used for passing cooling gas and lubricating oil through the housing should also guarantee the airtightness of the assembly, while maintaining mechanical properties suitable for application thereof. At present, the union of copper fluid-passers can be carried out by mechanical fixing or by brazing.

Brazing is one of the most usual procedures for joining copper connectors to the steel housing of an airtight compressor. The connectors may also be called fluid-passage tubing or fluid-passers and are used as passageway for cooling gas and lubricating oil. Naturally airtight compressors are equipped with suction, discharge and process fluid-passers and are joined by flame brazing, in an oven or by induction to a steel connector. This steel connector is later resistance welded to the compressor body wall.

Brazing requires the use of addition material, which should have, as fundamental characteristics, a lower melting point than the materials to be joined (copper and steel, in case of airtight compressors), low surface tension, high capillarity when in liquid state and good wettability on the surface of the materials to be joined. These characteristics are provided by silver-based addition materials used in conjunction with flows that promote the removal of fats and oxides from the surfaces to be jointed, guaranteeing the wettability of the addition metal molten on the base materials.

Besides the high cost of the inputs (addition material and flux), this operation requires some preparation time for application of the flux, positioning of the addition material and localized heating of the joint between the fluid-passage tubing and the steel connector. Then, the steel connector should still be joined to the housing by resistance welding, which in turn requires additional time and energy for this operation.

The resistance welding, which uses conventional sources—direct or alternating, monophase, two-phase or three-phase currents—works typically with transformers fed by the electric network with frequencies of 50 or 60 Hz. This type of source does not control the value of the welding current, since one controls only the power, besides not permitting a refined regulation of the welding time. The welding current is dependent both on the resistance of the secondary circuit—which includes the tweezers, electrodes, parts to be welded and contact resistance—and on the available voltage generated by the transformer.

The fact that one does not control the current directly and that a refined control over the welding time is not possible makes it difficult to join materials that have high thermal conductivity and reduced electric resistivity, as for example, copper, which has thermal conductivity of 385 W/m-K and electric resistivity of 1.7×10−6 ohm.cm. In these cases, it is necessary to concentrate the heat generated during the welding exactly on the joint where the union is to be made, not allowing the heat to dissipate to regions adjacent the weld. This control of the generation and concentration of heat in the welding region is only possible by using high-current pulses in short periods of time. By using conventional sources it is not possible to generate a high-current pulse with a controlled value in a short period of time, which makes it difficult to use these sources for joining parts of different thickness and of materials having high thermal conductivity, and to one does not achieve good results by using conventional sources.

Another way of carrying out the welding, is by using sources based on the discharge of a capacitor bank during the welding operation (capacitive discharge), which enables the flow of high currents in a short period of time. However, the value of the current, as well as that of the welding time, are not directly controlled. The current and the welding time depend on the charge voltage of the capacitor bank, on the capacitance of the circuit and on the total impedance of the secondary welding circuit. Thus, minor variations in the contact resistances between the electrodes and between the parts to be joined may cause significant oscillations in the circuit impedance and, consequently, in the current and welding time, causing malformation defects in the union or expelling of molten material. These characteristics of the capacitive-discharge welding reduce the qualities of the product, usually causing leakage failures of the compressor and generating extremely sharp edges, created by the expelling of liquid material during the welding, which represent a potential risk of occupational accidents. Due to these characteristics, the use of sources based on the capacitive discharge becomes unfeasible for the welding of fluid-passers in housings of airtight compressors.

One of the known prior techniques is described in document U.S. Pat. No. 6,2257,846 and refers to a way of connecting the tubing of an airtight compressor. According to the teachings of this document, in order for the connection to be airtight one uses concentrically aligned tubes, so that an external tube will trap the gas and the internal tube will transport the gas. Such a construction solves the airtightness problem, but is a complicated construction and requires control of the tubing measure tolerances under pain of gas-leakage problems. This document further describes a welding method in which the one welds the face of a tubing directly to a compressor. This solution, however, does not enable a perfect control in the welding process and, therefore, the union is not satisfactory.

Another similar solution is described in document U.S. Pat. No. 4,240,774. According to this technique, one uses tubes tightened to the compressor wall, so as to obtain an airtight connection. Although this solution brings about an airtight connection, it brings problems of practical nature, since there should be an adequate control of the tubing measure tolerances to prevent gas leakage.

### BRIEF DESCRIPTION OF THE INVENTION AND OBJECTIVES OF THE INVENTION

The objectives of the present invention are to replace the brazing process for joining the suction, discharge and process fluid-passers made of copper to the steel housing of the airtight compressor by direct welding, using sources of middle-frequency switched resistance welding. For this purpose, it was developed a geometry flanged on copper fluid-passers, which are welded to a planned region of the airtight compressor housing, as well as welding electrodes with a geometry suitable for the type of joint and of materials to be joined. In this way, it is possible to reduce the compressor manufacture time by replacing the brazing process by the mere welding of the copper fluid-passer (or fluid-passage tubing) directly to the compressor housing.

In order to achieve this objectives, switched sources, called also inverters, are used, since these have the capability of generating, in the transformer of the welding machine, a rectangular-wave alternating voltage with typical frequencies on the order of 1 kHz by using a transistor bridge. These sources are also known as sources of middle-frequency resistance welding. The use of a higher operational frequency reduces the iron contents required in the transformer, thus reducing the volume and weight, without performance loss. In addition, the utilization of power transistors enables one to control the average value of the welding current, independently of variations in the network voltage or of the impedance of the secondary circuit. The welding time can also be adjusted with a millisecond resolution. In this way, it is possible to generate high-current pulses with value controlled in short periods of time, which enables one to joint metals of high heat and electricity conductivity and of different thicknesses.

The objectives of the present invention are achieved by means of an airtight compressor comprising a housing and a fluid-transport tubing, the fluid-transport tubing passing through the housing through a passage orifice, the fluid-transport tubing comprising a weldable coupling means, the weldable coupling means being configured from a widening of the diameter of the fluid-transport tubing, the widening of the diameter having a dimension larger than the passage orifice and being configured along its length, the weldable coupling means being welded directly close to the border of the passage orifice.

Further, the objectives of the present invention are achieved by means of an airtight compressor comprising a housing and a fluid-transport tubing, the fluid-transport tubing passing through the housing through a passage orifice, the fluid-transport tubing comprising a weldable coupling means, the weldable coupling means being a flange configured from a widening of the diameter of the fluid-transport tubing, the widening of the diameter having a dimension larger than the passage orifice and being configured along its length, the housing having a planned portion in the proximity of the orifice, the flange comprising compression walls, the compression walls forming an angle with the planned portion of the compression housing, the angle being greater than zero.

A further objective of the present invention is to provide a method of welding a fluid tubing to a compression housing, wherein brazing is eliminated. This objective is achieved by means of a welding method that comprises steps of arranging the fluid-transport tubing close to the passage orifice, so that the respective flange will rest close to the border of the passage orifice; arranging a housing electrode and a tubing electrode, respectively, close to the planned portion of the housing and close to the body and to the flange of the fluid-transport tubing; pressing the tubing electrode towards the flange and against the passage orifice; circulating an electric current through the tubing electrodes and housing electrodes and keeping the current circulating until a contact edge of the flange has joined the border of the passage orifice.

Further with regard to the methodology, the objectives of the present invention are achieved by the step of pressing the tubing electrode toward the flange, displacing the tubing electrode toward the housing, as the current circulates through the flange, so as to deform the flange gradually and decrease the angle formed between the compression walls of the flange and the housing, carrying out the deformation of the flange until the angle between the compression walls of the flange and the housing has been reduced to zero.

Moreover, the objectives of the present invention are also achieved by means of a fluid-transport tubing, particularly applicable to an airtight compressor comprising a housing having a passage orifice for the fluid-transport tubing, the fluid-transport tubing comprising weldable coupling means which is configured from a widening in the diameter of the fluid-transport tubing, the widening in the diameter having a dimension larger than the diameter of the passage orifice and being configured along its length, the weldable coupling means being weldable directly close to a border of the passage orifice.

### BRIEF DESCRIPTION OF THE DRAWINGS

The present invention will now be described in greater detail with reference to an embodiment represented in the drawings. The figures show:

FIG. 1 represents a schematic cross-sectional drawing of the present-day form of union, by brazing the copper fluid-passer to a steel connector, which is then hermetically joined to the compressor housing by means of resistance welding; and

FIG. 2 represents the direct welding of the fluid-transport tubing onto the steel surface of the compressor housing, carried out by using the special geometry of the tubing and of electrodes with a geometry configured for the present invention;

FIG. 3 shows a graph of the variation of the electric resistance between metallic surfaces during the resistance welding.

### DETAILED DESCRIPTION OF THE FIGURES

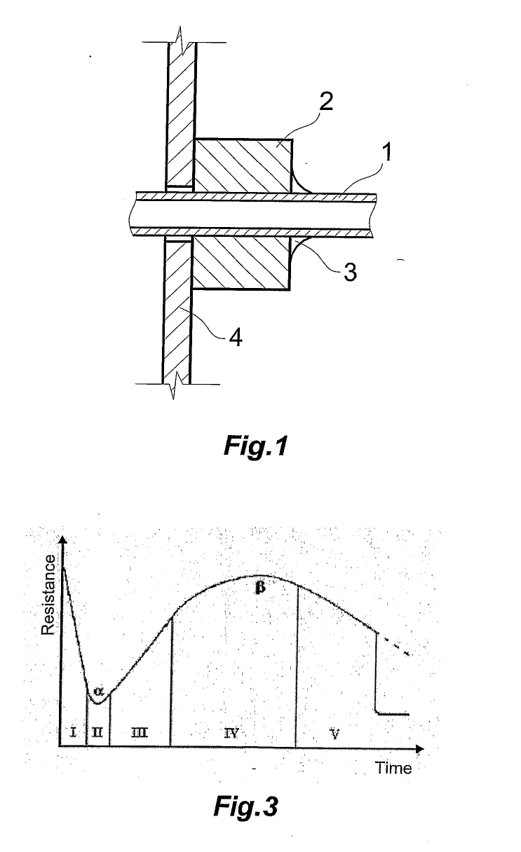

As can be seen in FIG. 1, according to the prior art, the union of fluid-passers (or fluid-passage tubing) made of copper is applied to the steel housing of airtight compressors used in cooling. In this configuration, a tubing 1 is flame brazed by induction or in a furnace to the cylindrical connector 2 made of carbon steel. The assembly formed by tubing 1 and the cylindrical connector 2 after the brazing operation is then joined externally to the steel housing 4 of the compressor (not shown) by means of resistance welding.

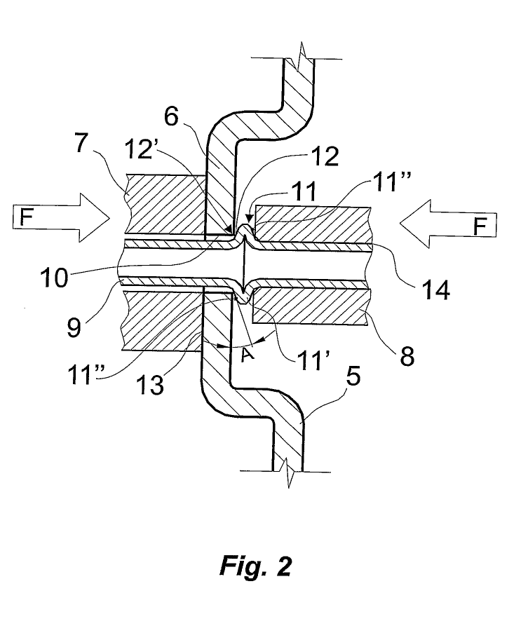

As can be seen in FIG. 2, according to the teachings of the present invention, in order to achieve the desired objectives the brazing and the use of the cylindrical connector 2 are eliminated by merely welding the fluid-transport tubing 9 to the compressor housing 5.

FIG. 3 illustrates the steps of the welding process comprising the phases I to V, which have the following behavior: in Phase I the surfaces of the metals rest against each other. Microscopically, the surface of one metal is rough, and in this step only the roughness peaks of each surface touch each other, and then there is a break of the surface that is covered by oxides and fats. One can note that the resistance drops drastically, as the oxides and fats are broken, and the process enters into the Phase II, when the softening of the roughness takes place, and one can note that the electric resistance at point a is minimum. After this phase, the process enters into Phase III and there is a rise in temperature, which causes the electric resistance to increase again, until the process enters into Phase IV, when occurs the beginning of the melting and formation of the weld lens begin, that is to say, the surfaces begin to melt, reaching a stabilization point in the resistance close to point β. In the next phase, i.e. Phase V, the growth of the weld lens and the mechanical collapse take place, which can be clearly seen in the tooth caused at the curve, which represents the moment when the material is heated and subjected to such a force that the molten metal is expelled, causing splashes and sparks.

Bearing in mind this behavior according to the present invention, one should foresee a configuration for the compressor and welding method that can control precisely the welding time, so that one will reach the Phase III and thus the union between the compressor elements is guaranteed, without occurring airtightness problems or metal splashes.

In general, one can note that the airtight compressor comprises the housing 5 and the fluid-transport tubing 9, which passes through the housing 5 through a passage orifice 10.

The fluid-transport tubing 9 comprises weldable coupling means 11, configured from a widening in the diameter of the fluid-transport tubing 9, the diameter widening having a dimension larger than the diameter of the passage orifice 10 and being configured along its length so that it will be welded directly close to the border 12′ of the passage orifice 10.

Preferably, the weldable coupling means 11 is configured from a flange 11′ shaped directly on the fluid-transport tubing, thus forming a contact edge 12. The flange wall 11′ should form an angle of aperture “A” (see FIG. 2) with the planned portion 6 with a value higher than zero and, more specifically, an acute angle, so that the contact of the flange 11′ with the planar surface 6 will have a contact area as small as possible. This contact edge 12 will rest directly on the compressor housing 5, so that the housing 5 and the flange 11′ will be welded to each other at the passage orifice 10, the welding being carried out by passing an electric current.

In order to guarantee the continuous electric contact between the flange 11′ of the fluid-passage tubing 9 and the passage of the welding process through the Phases I to III, in the surface of the compressor housing, which usually has a cylindrical geometry, it is necessary to plan a small housing region, thus forming a planned portion 6 at the proximity of the orifice 10. An internal electrode or housing electrode 7 should guarantee good electric contact with the planned portion 6 through the planar contact surface 13. However, this housing electrode 7 should not come into contact with the fluid-passage tubing 9, so that the electric current will circulate only through the contact surface 13. The sizing of the planar contact surface 13 should guarantee that the contact resistance between the housing electrode 7 and the planned portion 6 will be lower than the contact resistance of border 12 close to border 12′.

A tubing electrode 8 is provided close to the fluid-passage tubing 9 and should be shaped so as to provide a tubular contact surface 14 to involve the fluid-passage tubing 9, thus guaranteeing an electric contact between the parts.

In this configuration, a current is passed through the border contact edges 12, planar 13, tubular 14, through the fluid-passage tubing 9 and through the compressor housing 5. During the passage of the current, the housing electrode 7 is simultaneously pressed against the planar contact surface 13 (see indications of the direction of the F forces applied to the housing electrode and tube electrode).

The flange 11′ should be configured so that, at the time of welding it can be urged in the direction of prolongation of the fluid-transport tubing 9 and increase the area of the contact edge 12 close to the border 12′ of the passage orifice 10, the widening in the diameter of the fluid-transport tubing 9, which forms the flange 11′, comprises compression wall 11″ configured so that, at the time of welding, the tubing electrode 8 can press the compression walls 11″ toward the housing 5, so as to enlarge the area of the contact edge 12 close to the border 12′ of the passage orifice 10.

Operationally, the current is applied to the electrodes with the high-current passage through the electric circuit formed by the housing electrode 7 connected with the housing 5 through the planar contact surface 13, the contact edge 12 connected to the flange 11′ through the border 12′ of the housing 5, and the connection of the tube electrode 8, connected to the fluid-passage tubing 9 through the tube surface 14. Once an electric current is passed by controlled pulses, a localized heating takes place on the contact edge 12. In this way, the flange 11′ shaped on the fluid-passage tubing 9 reaches a high temperature, which, combined with the compression force caused by the housing electrode 7 and tubing electrode 8 promotes the deformation of the flange 11′. The surface of the compression wall on the planned portion 6, at the proximity of the passage orifice 10 is also heated by the Joule effect caused by the passage of current through the contact edge 12. As the flange 11′ of the fluid-passage tubing 9 deforms by the above-described effect, the area of the contact edge of the region 12 gradually increases. Due to this deformation and to the heating caused by the Joule effect, there is a variation in the contact resistance of the region of the contact edge 12. However, the value of the electric current is not altered during this time, since it is constantly controlled by the middle-frequency switched source used for this welding. The current would not be kept constant if one used conventional sources of resistance welding or even sources of capacitive discharge, since the variation of the electric resistance of the contact edge 12, would cause a variation in the total impedance of the secondary circuit and, consequently, fluctuations in the welding current.

The high temperature of the fluid-passage tubing 9 at the contact edge 12, combined with the compression force caused by the housing electrode 7 and tubing electrode 8 and with the heating of the peripheral surface at the passage orifice 10, promotes the diffusion and coalescence of the material of the fluid-passage tubing, which may be copper but is not restricted to this material, at the roughness on the surface of the material of the compressor housing, which may be made of carbon steel but is not restricted to this material. The use of the middle-frequency switched sources allows the welding time to be between a minimum value, which guarantees the adequate dimensions of the deformed surface union 12 so that the welding will have adequate mechanical properties, and a maximum value, which prevents one of the materials from melting, which could cause expulsion of the liquid material, forming splashes and cutting surfaces at the welded joint. The time selection range for this process usually is shorter than 5 ms, a fact that make unfeasible the use of conventional sources, where the resolution of the welding time is of 8 ms (a semi-cycle for the power supply system with a frequency of 60 Hz).

The result of this procedure is a perfect union of the materials of the fluid-passage tubing 9 with the housing 5, which guarantees airtightness of the assembly, with mechanical properties adequate for application of the compressors in cooling systems, without the need for brazing. This result would not be achievable with the previous techniques, mainly by the welding technique that employs capacitive discharge sources, since according to this technique used previously, the compressor housing will be protected from splashes of metallic material, which confers an unacceptable finish to the product, as well as an airtightness result with quality faults. Moreover, since the current and the time are not directly controllable in the case of use of capacitive-discharge sources, the mere alteration in the amount of oxides and fats from a part to another causes an abrupt variation in the welding quality.

As to the methodology itself, the following steps are foreseen:

arranging the fluid-transport tubing 9 close to the passage orifice 10, so that the respective flange 11′ will rest close to the border 12′ of the passage orifice 10;

arranging a housing electrode 7 and the tubing electrode 8, respectively, close to the planned portion 6 of the housing and close to the flange 11′ of the fluid-transport tubing 9;

pressing the tubing electrode 8 toward the flange 11′ and against the passage orifice 10, displacing the tubing electrode 8 toward the housing 5 as the current circulates through the flange 11′;

circulating an electric current through the tubing electrode and housing electrode and keeping the current circulating until a contact edge 12 of the flange 11′ has been arranged at the border 12′ of the passage orifice, and circulating current through the flange 11′ until the material of the tubing 9 will be anchored at the roughness of the housing 5 surface at the proximity of the orifice 10, guaranteeing an airtight union with good mechanical properties.

At the step of circulating a current, one should foresee that the welding should be made within the Phase III and, along the welding process, in the step of pressing the tubing electrode towards the flange 11′, the tubing electrode 8 should be displaced toward the housing 5, as the current circulates through the flange 11′ so as to deform gradually the flange 11′ and decrease an angle “A” formed between the compression walls 11″ of the flange 11′ and the housing 5 until the angle “A” has been reduced to zero and the compression walls 11″ of the flange 11′ and the housing 5 have become parallel.

With the construction of the compression by following the teachings of the present invention and with the methodology proposed by the above method, it is possible to eliminate the brazing step foreseen in the previous techniques and the sue of a steel connector, eliminating the manufacturing steps and parts during the production process, thus achieving a less expensive compressor.

A preferred embodiment having been described, one should understand that the scope of the present invention embraces other possible variations, being limited only by the contents of the accompanying claims,

1. An airtight compressor comprising a housing and a fluid-transport tubing, the fluid-transport tubing passing through the housing through a passage orifice,
the fluid-transport tubing comprising weldable coupling means,
the weldable coupling means being configured from a widening in the diameter of the fluid-transport tubing, the widening of the diameter having a dimension larger than the diameter of the passage orifice and being configured along its length,
the weldable coupling means being welded directly close to a border of the passage orifice;
the compressor being characterized in that the housing is welded to the fluid-transport tubing by using a middle-frequency current, the middle-frequency current being provided by a switched source, the fluid-transport tubing being made of copper and the housing being made of steel.

2. A compressor according to claim 1, characterized in that the weldable coupling means is configured from a flange shaped directly on the fluid-transport tubing, the flange having a contact edge, the contact edge resting directly at the compressor housing wall, the housing and the flange being welded to each other.

3. A compressor according to claim 2, characterized in that the welding between the housing and the flange is made at the passage orifice.

4. A compressor according to claim 3, characterized in that the flange is configured so that, upon welding between the flange and the orifice, there is a greater electric resistance to the passage of the electric current at the interface between the flange and the passage orifice.

5. A compressor according to claim 4, characterized in that the flange is configured so that, during the welding, the contact resistances between a welding electrode and the fluid-transport tubing and one electrode and the housing are lesser than the resistance of the interface between the fluid-transport tubing and the housing.

6. A compressor according to claim 5, characterized in that the housing has a planar portion at the proximity of the orifice.

7. A compressor according to claim 6, characterized in that the flange comprises compression walls, the compression walls forming an angle A with the planar portion of the compressor housing.

8. A compressor according to claim 7, characterized in that the angle A is greater than zero.

9. A compressor according to claim 7, characterized in that the angle A is acute.

10. A compressor according to claim 6, characterized in that the flange is configured so that, upon welding, it can be pressed in the direction of prolongation of the fluid-transport tubing and increase the area of the contact edge close to the border of the passage orifice.

11. A compressor according to claim 7, characterized in that the widening in the diameter of the fluid-transport tubing that forms the flange comprises compression walls and is configured so that, upon welding, the welding electrode can press the compression walls toward the housing so as to increase the area of the contact edge close to the border of the passage orifice.

12. A compressor according to claim 11, characterized in that the compression walls are configured so that, at the time of welding, the angle A will become zero as the welding process takes place.

13. A compressor according to claim 1, characterized in that, upon welding, a housing electrode configured for supporting the planar portion rests against a planar contact surface of the housing, and that a tubing electrode is configured to provide a tubular contact surface to involve the fluid-passage tubing.

14. An airtight compressor comprising a housing and a fluid-transport tubing, the fluid-transport tubing passing through the housing through a passage orifice,
the fluid-transport tubing comprising weldable coupling means,
the weldable coupling means being a flange that is configured from a widening in the diameter of the fluid-transport tubing, the widening in the diameter having a dimension greater than the diameter of the passage orifice and being configured along its length,
the compressor being characterized in that
the housing has a planar portion at the proximity of the orifice,
the flange comprising compression walls, the compression walls forming an angle A with the planar portion of the compressor housing, the angle A being greater than zero.

15. A compressor according to claim 14, characterized in that the angle is acute.

16. An airtight compressor comprising a housing and a fluid-transport tubing, the fluid-transport tubing passing through the housing through a passage orifice,
the fluid-transport tubing comprising weldable coupling means,
the weldable coupling means being configured from a widening in the diameter of the fluid-transport tubing, the widening of the diameter having a dimension larger than the diameter of the passage orifice and being configured along its length,
the weldable coupling means being welded directly close to a border of the passage orifice;
the compressor being characterized in that the compressor housing and the fluid-transport tubing are suitable for applying a middle-frequency current provided by a switched source, the middle-frequency current being able to weld the compressor housing and the fluid-transport tubing.

17. Use of a switched source for welding a fluid-transport tubing to a compressor housing, the fluid-transport tubing passing through the housing through a passage orifice,
the fluid-transport tubing comprising weldable coupling means, the weldable coupling means being configured from a widening in the diameter of the fluid-transport tubing, the widening of the diameter having a dimension larger than the diameter of the passage orifice and being configured along its length,
the weldable coupling means being welded directly close to a border of the passage orifice,
characterized in that the switched source is a middle-frequency current source.

18. A method of welding a fluid tubing to a compressor housing, the fluid-transport tubing passing through the housing through a passage orifice, the method being characterized by comprising the steps of:
arranging the fluid-transport tubing close to the passage orifice so that a respective flange will rest close to a border of the passage orifice;
arranging a housing electrode and a tubing electrode, respectively, close to the planar portion of the housing and close to the flange of the fluid-transport tubing;
pressing the tubing electrode toward the flange and against the passage orifice;
circulating a electric current by means of a switched source through the tubing and housing electrodes and keeping the current circulating until a contact edge of the flange has joined the border of the passage orifice.

19. A method according to claim 18, characterized in that, in the step of pressing the tubing electrode toward the flange, there is a displacement of the tubing electrode toward the housing as the current circulates through the flange, so as to deform gradually the flange and decrease an angle A formed between the compression walls of the flange and the housing.

20. A method according to claim 18, characterized in that the deformation of the flange is made until the angle A between the compression walls of the flange and the housing has been reduced to zero.

21. A method according to claim 18, characterized in that the welding is carried out by using welding sources by middle-frequency switched sources, also known as middle-frequency inverters.

22. A fluid-transport tubing applicable to an airtight compressor comprising a housing having a passage orifice for the fluid-transport tubing,
the fluid-transport tubing comprising weldable coupling means and being characterized in that the weldable coupling means is configured from a widening in the diameter of the fluid-transport tubing, the widening in the diameter having a dimension larger than the diameter of the passage orifice and being configured along its length,
the weldable coupling means being weldable directly close to a border of the passage orifice by means of a switched source.

23. A tubing according to claim 22, characterized in that the weldable coupling means is configured from a flange shaped directly on the fluid-transport tubing, the flange having a contact edge, the contact edge being supportable directly at the compressor housing wall, the housing and the flange being weldable to each other.

24. A tubing according to claim 22 characterized in that the flange is configured so that, upon welding between the flange and the orifice, there is a greater electric resistance to the passage of the electric current at the interface between the flange and the passage orifice.

25. A tubing according to claim 22, characterized in that the flange is configured so that, upon welding, the contact resistances between a welding electrode and the fluid-transport tubing and an electrode and the housing will be lesser than the resistance of the interface between the fluid-transport tubing and the housing.
